(19) United States
(12) Patent Application Publication
(10) Pub. No.: US 2011/0107761 A1
(43) Pub. Date: May 12, 2011

(54) Hybrid high efficiency motor

(76) Inventor: Michael Campbell Rowland, Slidell, LA (US)

(21) Appl. No.: 12/590,516

(22) Filed: Nov. 10, 2009

(51) Int. Cl. F02G 5/02

(52) U.S. Cl. 60/616

(57) ABSTRACT

This device is an improvement on an internal combustion engine (ICE) in that the device is a hybrid of an ICE directly linked to a heat engine (HE) via an adjustable transmission to drive the power shaft for the transmission for the car, boat, generator or other equipment. The improvement provides a means of directly receiving the heat from the exhaust of the ICE and using it to power the HE which is linked via an adjustable transmission, such as a continuous variable transmission (CVT). This linkage allows the HE to use the power of the ICE to start turning until the HE has warmed up enough that it can contribute power to the ICE crank shaft, and subsequent final common power shaft for the two engines, such that it acts as a unified, hybrid motor that powers the transmission of a truck, generator or other equipment.

### CROSS REFERENCE TO RELATED APPLICATIONS

Not Applicable.

### STATEMENT OF FEDERALLY SPONSORED RESEARCH/DEVELOPMENT

Not applicable.

### SEQUENCE LISTING REFERENCE

Not applicable.

### BACKGROUND OF THE INVENTION

Increasing the efficiency of an internal combustion engine has in the past been largely limited to adjustments to the feeding of the air and fuel for combustion, while use of the exhaust heat of combustion has been largely ignored. Internal combustion engines (ICE) commonly produce a lot of waste heat. Heat engines (HE) such as a Stirling Cycle engine convert heat energy into mechanical energy. What has been lacking to date is a compact, efficient means of combining these two engines into a hybrid motor.

The rate of rotation of the ICE crankshaft is generally controlled by the amount of fuel supplied to the ICE, whereas the crankshaft speed of the HE is largely affected by the thermal difference between the hot side of the HE and the cold side. With the advent of the continuously variable transmission (CVT) there is now a means of directly mechanically linking the power output of these two engines so that both may run at their optimal speeds (which may be vastly different rotations per minute) but efficiently combine their power to form a hybrid motor that is the summation of the power input of the ICE and the HE. None of the prior art listed below does this in a direct manner as the hybrid motor that is outlined in this patent application.

Prior art related to this application includes an ICE which is capable of switching between homogeneous charge compression ignition combustion and diesel combustion by Hashimoto (U.S. Pat. No. 7,597,090 filed Mar. 12, 2007), but no direct link with a HE is mentioned.

Kalina (U.S. Pat. No. 7,458,217 filed Sep. 15, 2005) described a system for utilization of waste heat from ICE's, yet the system mentioned was for electrical power generation via a heat recovery vapor generator.

Yaguchi (U.S. Pat. No. 7,458,215 filed Sep. 24, 2004) depicts a Stirling engine that is compact, but no mechanism is given for attaching it to an ICE.

Yamanaka (U.S. Pat. No. 7,454,912 filed Dec. 22, 2005) gave a description of “a device for utilizing waste heat from a heat engine comprises a Rankine cycle including a pump, a heating device, an expansion device, and a condenser device, and a controller for controlling an operation of the Rankine cycle.” This device is not a direct mechanical linking of the ICE and the HE via a transmission.

Yamamoto (U.S. Pat. No. 7,118,501 filed Aug. 28, 2003) has a V-belt continuously variable transmission, but no mention of specifically linking it with an ICE and HE.

Minemi (U.S. Pat. No. 6,948,316 filed Aug. 4, 2004) describes a Rankine cycle system that uses heat to power an evaporator and condenser circuit for power, not directly linking the ICE and HE with an adjustable transmission.

None of these prior inventions uses the combination of an ICE directly mechanically linked with a HE via an adjustable transmission (such as a CVT) wherein the ICE's waste heat power can be harnessed by a HE and directly mechanically added to the power of the ICE crankshaft. Thus the final driveshaft of the hybrid motor combines the power of the ICE crankshaft with the power recovered from the “waste” heat of the ICE via a HE and a variable transmission.

### BRIEF SUMMARY OF THE INVENTION

The present invention solves the aforementioned problems of utilizing waste heat from an ICE, in a compact fashion that may be retrofitted to existing ICE's in many circumstances, thus providing improved fuel economy. Increasing the efficiency of an internal combustion engine has in the past been largely limited to adjustments to the feeding of the air and fuel for combustion, while use of the exhaust heat of combustion has been largely ignored. Of the few designs that involve mentioning any Stirling cycle use of waste heat, none have been directly linked to the internal combustion engine's crankshaft via an adjustable transmission so that the Stirling Cycle engine contributes to the internal combustion engine's power output directly. Using the Carnot equation of 1−(T2/T1), then the calculated maximum efficiency of the HE from the heat of the exhaust is roughly 21 percent that can be added back to the ICE's power. That is based on 1000 degrees Fahrenheit (373 degrees Kelvin) for the exhaust temperature from the ICE, T1, and the ambient air temperature of 70 degrees Fahrenheit (294 degrees Kelvin), T2. The advantage of this is as follows, if an engine is losing 100 Horsepower in waste heat, then it could be like getting 21 Horsepower back to add to the ICE in power. Friction losses will decrease this percentage of recovered power, yet motors operating in cold climates, thus a higher temperature differential, could potentially exceed the 21 percent of recovered power.

The ICE exhaust would flow directly to the hot side of the HE through heat fins or other means of heat exchange and then out the exhaust pipe. The cold side of the HE would use a coolant (such as sea water in the case of ocean going vessels) flowing across the cold side of the HE across heat fins or other means of heat exchange to help maintain the temperature differential across the HE. The ICE could use the coolant from the HE or coolant in a separate circuit for the ICE alone.

Initially when the ICE is started the HE would be parasitic, in that until the exhaust heats the hot side of the HE in a minute or so, the HE would not be contributing any power to the hybrid motor arrangement, and would be dependent upon the ICE to turn the crankshaft of the HE. Once the HE was up to operating temperature it would then be contributing power to the overall hybrid motor arrangement.

To link the ICE and HE mechanically would be an adjustable transmission, ideally a CVT. This is important in a variety of situations. In a stationary generator the ICE would need to be run at the ideal speed for optimum efficiency, whereas the optimum speed of the HE might vary according to the changes in the ambient temperature. A part of the CVT would need to be a circuit or mechanical means that would adjust the gear ratio so that the CVT can turn synchronously at its optimal speed with the ICE for maximal combined power output in the final drive shaft. In a motor vehicle the changes in the gear ratios in the CVT would be even more frequent than a stationary generator.

In a series configuration the ICE could be set up so that it has a crankshaft that extends from both ends of the ICE, with one end being the power shaft to drive the alternator in the case of a generator, or the transmission in the case of an automobile or ship. The other end of the crankshaft of the ICE would be attached to a CVT which sits between the ICE and the HE crankshaft.

In a parallel configuration the ICE crankshaft and the HE crankshaft would feed into a CVT such that the HE crankshaft speed is matched via the CVT to the ICE crankshaft speed so the final output speed is the same as the ICE but the power is additive. This could be accomplished by having half of the CVT attached directly to the crankshaft of the ICE and half of the CVT directly attached to the crankshaft of the HE, and the power for the machinery being tapped off the end of the ICE crankshaft that continues through the CVT.

### BRIEF DESCRIPTION OF SEVERAL VIEWS OF THE DRAWING

FIG. 1 is a view from the top of the hybrid motor, showing the ICE parallel to the HE with the adjustable transmission mechanically linking the two.

FIG. 2 is a view from the bottom of the same hybrid motor.

FIG. 3 is a front view of the same hybrid motor.

FIG. 4 is a view from the HE side of the same hybrid motor.

FIG. 5 is a view from the top of the hybrid motor with the ICE and HE in series.

### DETAILED DESCRIPTION OF THE INVENTION

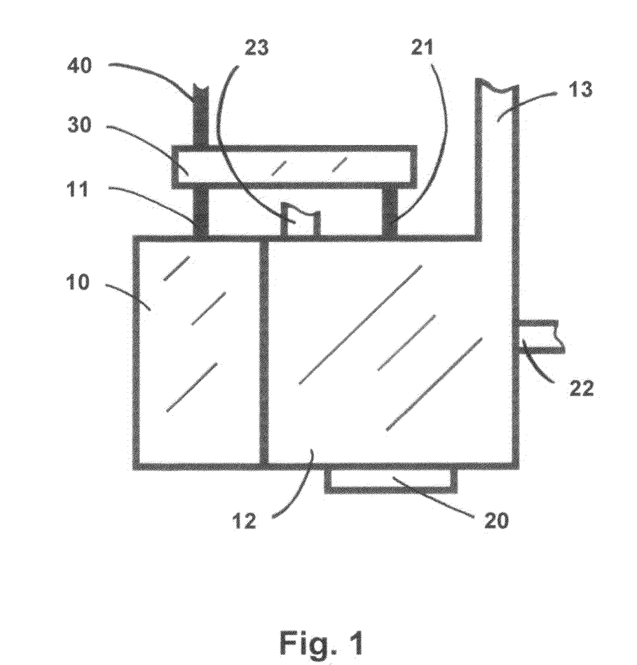

The primary components of the high efficiency hybrid motor are the ICE, the HE, the exhaust manifold of the ICE feeding the hot gases to the HE, the adjustable transmission linking the ICE and HE, and cooling heat exchanger for the HE as seen FIGS. 1, 2, 3, 4, and 5.

Referring to FIG. 1, the ICE 10 has the hot exhaust gases flow via the exhaust manifold 12 over the top of the HE 20 and out the exhaust pipe 13. The crankshaft 11 from the ICE 10 goes through the adjustable transmission 30 and out the other side to become the power shaft 40 for whatever device is being powered by the hybrid motor. The HE crankshaft 21 goes into the adjustable transmission 30, where it is mechanically linked to the driveshaft 11 of the ICE 10. The coolant intake pipe 22 for the HE 20 can be seen, as well as the coolant outflow pipe 23 for the HE 20.

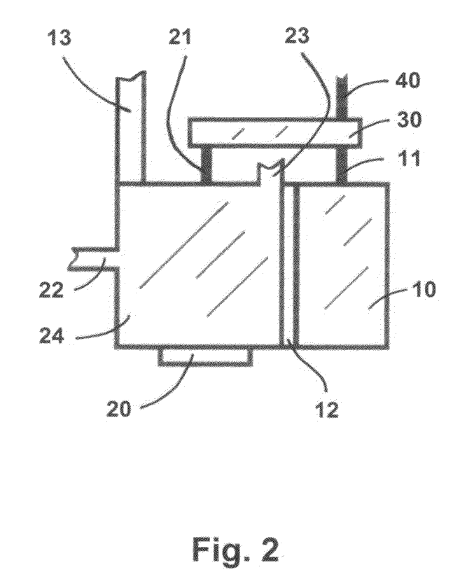

In FIG. 2 the bottom view better shows the coolant heat exchanger 24 on the bottom of the HE 20.

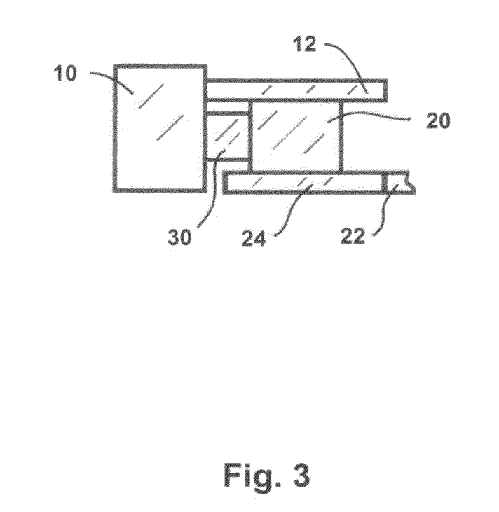

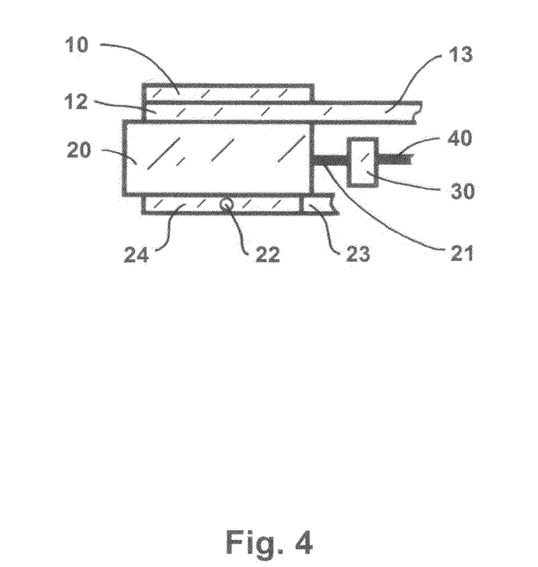

The front view in FIG. 3 and the side view seen in FIG. 4 better show how the HE 20 is sandwiched between the exhaust manifold 12 from the ICE 10 on the top and the coolant heat exchanger 24 for the HE 20 on the bottom.

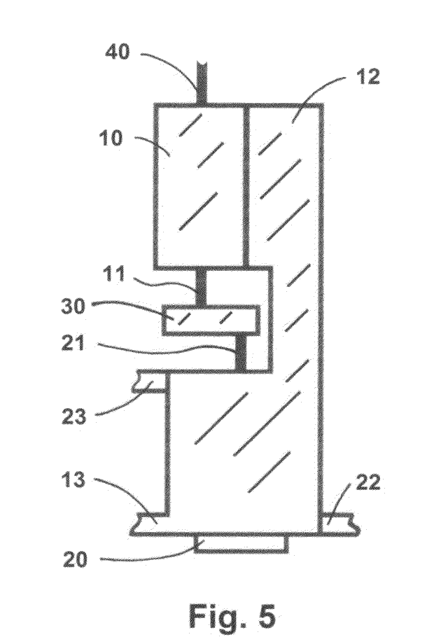

An alternative series configuration is shown in FIG. 5 where the HE 20, and adjustable transmission 30, are on one end of the ICE 10, and the power shaft 40 is on the other end of the ICE 10.

It is therefore understood that although the present invention has been specifically disclosed with the preferred embodiment and examples, modifications to the design concerning shape and sizing and arrangement may be apparent to those skilled in the art, and such modifications and variations are considered to be within the scope of the invention and the appended claims.

I claim:

1. A hybrid high efficiency motor for use with equipment comprising:
a: an internal combustion engine with
a crankshaft extending out one or both ends of said internal combustion engine, one or both of said crankshafts serving as the power shaft;
exhaust vented via an exhaust manifold;
b: a heat engine with
the heat received from said the exhaust manifold of said internal combustion engine;
a cooling heat exchanger for helping maintain a thermal differential across said heat engine;
a crankshaft extending out one or both ends of said heat engine;
c: an adjustable transmission that mechanically links said crankshaft of said internal combustion engine and said crankshaft of said heat engine as to make the rotational power of said heat engine match the rotation of said crankshaft of said internal combustion engine such that power is recovered from the exhaust heat from said internal combustion engine via said heat engine and ultimately added back to said power shaft of said internal combustion engine.

2. The hybrid high efficiency motor of claim 1
wherein said heat engine is a Stirling Cycle engine.

3. The hybrid high efficiency motor of claim 1
wherein said adjustable transmission is a continuously variable transmission.
